(19) United States
(12) Patent Application Publication
(10) Pub. No.: US 2025/0368097 A1
(43) Pub. Date: Dec. 4, 2025

(54) SEAT ROTATING DEVICE

(71) Applicant: TOYOTA BOSHOKU KABUSHIKI KAISHA, Aichi-ken (JP)

(72) Inventors: Shinichi ITO, Miyoshi-shi (JP); Tadasuke HIGUCHI, Aichi-ken (JP)

(73) Assignee: TOYOTA BOSHOKU KABUSHIKI KAISHA, Aichi-ken (JP)

(21) Appl. No.: 19/214,777

(22) Filed: May 21, 2025

(30) Foreign Application Priority Data
May 30, 2024 (JP) 2024-088020

(51) Int. Cl. B60N 2/14

(52) U.S. Cl. CPC B60N 2/146

(57) ABSTRACT

A seat rotating device includes: a transmission state selection mechanism that is provided between a rotary disc and a release plate and selects between a non-transmission state in which rotation of the release plate is not transmitted to the rotary disc and a transmission state in which rotation of the release plate is transmitted to the rotary disc; and a lock unit that is provided between the rotary disc and an outer circumferential ring and provided to select between a rotationally fixed state in which rotation of the rotary disc with respect to the outer circumferential ring is fixed and a rotatable state in which rotation of the rotary disc with respect to the outer circumferential ring is allowed.

### CROSS REFERENCE TO RELATED APPLICATIONS

This nonprovisional application is based on Japanese Patent Application No. 2024-088020 filed on May 30, 2024 with the Japan Patent Office, the entire contents of which are hereby incorporated by reference.

### BACKGROUND OF THE INVENTION

### Field of the Invention

This invention relates to a seat rotating device.

### Description of the Background Art

A device for rotating a seat body mounted on a vehicle is described in, for example, Chinese Patent Publication No. 116811685. According to the rotating device disclosed in Chinese Patent Publication No. 116811685, multistep locking of a rotation angle of a rotary disc is achieved.

### SUMMARY OF THE INVENTION

According to the configuration disclosed in Chinese Patent Publication No. 116811685, the lock position of the rotation angle of the seat body is at predetermined locations, and cannot be fixed at an arbitrary location.

An object of the present disclosure is to provide a seat rotating device configured to enable a lock position of a rotation angle of a seat body to be set to an arbitrary location.

A seat rotating device of this invention is a seat rotating device that rotates a seat body with respect to a placement base, the seat rotating device including: a rotary disc that supports the seat body; a base that supports the rotary disc rotatably with respect to the placement base; an outer circumferential ring fixed to the base and arranged on an outer circumferential side of the rotary disc; a release plate placed on the rotary disc and having a same rotation center as the rotary disc; a drive device that rotates the release plate about the rotation center as a rotation axis; a transmission state selection mechanism provided between the rotary disc and the release plate, the transmission state selection mechanism selecting between a non-transmission state in which rotation of the release plate is not transmitted to the rotary disc, and a transmission state in which rotation of the release plate is transmitted to the rotary disc; and a lock unit provided between the rotary disc and the outer circumferential ring, the lock unit being provided to select between a rotationally fixed state in which rotation of the rotary disc with respect to the outer circumferential ring is fixed, and a rotatable state in which rotation of the rotary disc with respect to the outer circumferential ring is allowed.

When the seat rotating device is in a first state, the non-transmission state is selected by the transmission state selection mechanism, and the rotationally fixed state is selected by the lock unit.

When the seat rotating device is in a second state, the drive device is driven from the first state to rotate the release plate in one direction, to thereby effect a transition of the lock unit from the rotationally fixed state to the rotatable state, and a transition of the transmission state selection mechanism from the non-transmission state to the transmission state, whereby the release plate and the rotary disc rotate in a synchronized manner, and rotation of the rotary disc allows selection of a desired rotation angle position for the seat body.

When the seat rotating device is in a third state, after the desired rotation angle position is selected for the seat body in the second state, the drive device is reversely driven to rotate the release plate by a prescribed angle in another direction opposite to the one direction, to thereby effect a transition of the lock unit from the rotatable state to the rotationally fixed state, and a transition of the transmission state selection mechanism from the transmission state to the non-transmission state, to return the seat rotating device to the first state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the configuration of a rotary seat mounted on a vehicle.

FIG. 2 is an exploded perspective view showing the configuration of a seat rotating device in an embodiment.

FIG. 3 is a perspective view showing the configuration of the seat rotating device in the embodiment.

FIG. 4 is a plan view showing the configuration of the seat rotating device in the embodiment.

FIG. 5 is a perspective view of a release plate of the seat rotating device in the embodiment.

FIG. 6 is a cross-sectional view taken along a line VI-VI as seen in a direction of arrows in FIG. 5.

FIG. 7 is a cross-sectional view taken along a line VII-VII as seen in a direction of arrows in FIG. 4.

FIG. 8 is a diagram showing a support structure for a rotary disc by a base as seen from VIII in FIG. 4.

FIG. 9 is a plan view of a lock unit of the seat rotating device in the embodiment.

FIG. 10 is a view as seen from an X direction in FIG. 9.

FIG. 11 is a plan view showing the position of a housed state of the lock unit in a lock unit housing annular groove.

FIG. 12 is a partial view showing the configuration of a rotary disc body portion.

FIG. 13 is a plan view showing the position of the release plate in a “rotationally fixed state.”

FIG. 14 is a plan view showing a state after the release plate is rotated by a first rotation angle.

FIG. 15 is a plan view showing a state after the release plate is rotated by a second rotation angle.

FIG. 16 is a plan view showing another form of the release plate.

FIG. 17 is a side view showing the shape of a wedge groove in the rotary disc body portion in another embodiment.

FIG. 18 is a side view showing a form of a wedge in another embodiment.

FIG. 19 is a side view showing a lock state by the wedge in another embodiment.

### DESCRIPTION OF THE PREFERRED EMBODIMENTS

A seat rotating device in an embodiment will be described below with reference to the drawings. When a reference is made to a number, an amount and the like in the embodiment described below, the scope of the present invention is not necessarily limited to the number, the amount and the like unless otherwise specified. The same or corresponding components are denoted by the same reference numerals and the same description may not be repeated. The use of appropriate combinations of features in the embodiment is originally intended.

A rotary seat shown below functions as a vehicle seat, in particular, as a car seat. “Front” shown in the drawings means a side of forward travel of a vehicle on which the rotary seat in the embodiment is mounted, “rear” means a side of rearward travel of the vehicle, “left” means a left hand side when viewed in a forward travel direction, “right” means a right hand side when viewed in the forward travel direction, “up” means an upper side of the vehicle, and “down” means a lower side of the vehicle, which is also similarly applicable in the drawings below.

Although the rotary seat shown below is illustrated with a seat located on the right with respect to a direction of travel of a vehicle being assumed, in a case of a seat located on the left with respect to the direction of travel of the vehicle, features shown below are arranged in symmetrical relation.

### <Rotary Seat 1>

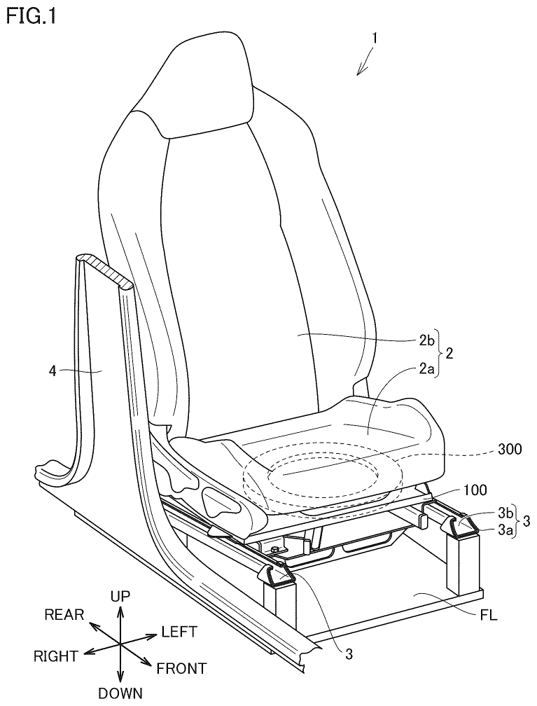

A schematic configuration of a rotary seat 1 will be described with reference to FIG. 1. FIG. 1 is a perspective view showing the configuration of rotary seat 1 mounted on a vehicle.

As shown in FIG. 1, rotary seat 1 includes a seat body 2 and a seat rotating device 300. Seat body 2 includes a seat cushion 2a and a seat back 2b. Seat cushion 2a constitutes a seat that supports the hip portion of an occupant. Seat back 2b supports the back of an occupant seated on seat cushion 2a. Seat body 2 is disposed on a floor FL of the vehicle.

A pair of seat sliders 3 that slides seat body 2 in a front-rear direction of the vehicle with respect to floor FL is attached to floor FL. Seat sliders 3 are arranged at a distance from each other in a width direction (a lateral direction) of the vehicle. Each seat slider 3 includes a lower rail 3a and an upper rail 3b.

Lower rail 3a is fixed to floor FL in a posture in parallel to the front-rear direction of the vehicle. Upper rail 3b is displaceable relatively to lower rail 3a in the front-rear direction of the vehicle (the longitudinal direction of lower rail 3a).

Seat rotating device 300 is disposed between an upper surface of a base plate 100, which can be moved in the front-rear direction by seat sliders 3, and a lower surface of seat cushion 2a. With this configuration, seat body 2 can be moved in the front-rear direction, and can be rotated to an arbitrary rotation position with respect to base plate 100 (placement base) and fixed at the position by seat rotating device 300.

Although the position of rotary seat 1 with respect to the vehicle is assumed to be on the pillar 4 side (a driver seat in a case of a steering wheel located on the right side) in the present embodiment, the position may be at a passenger seat or a rear seat.

### <Seat Rotating Device 300>

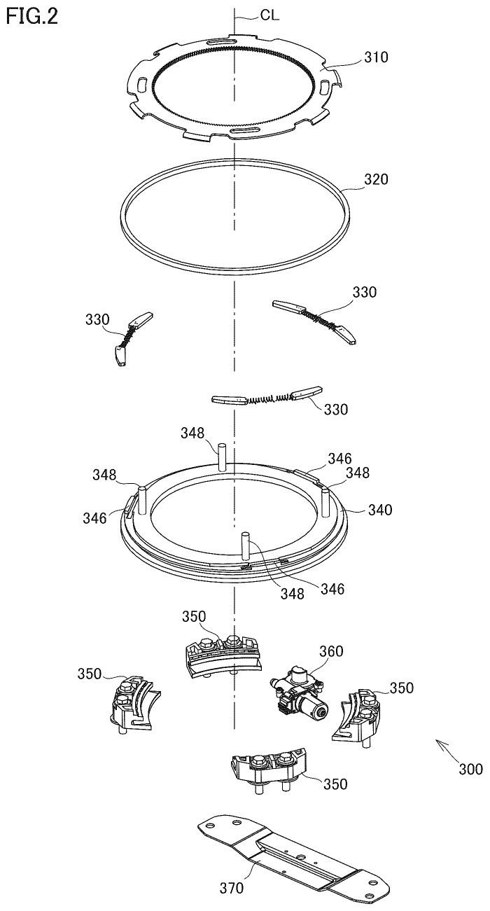

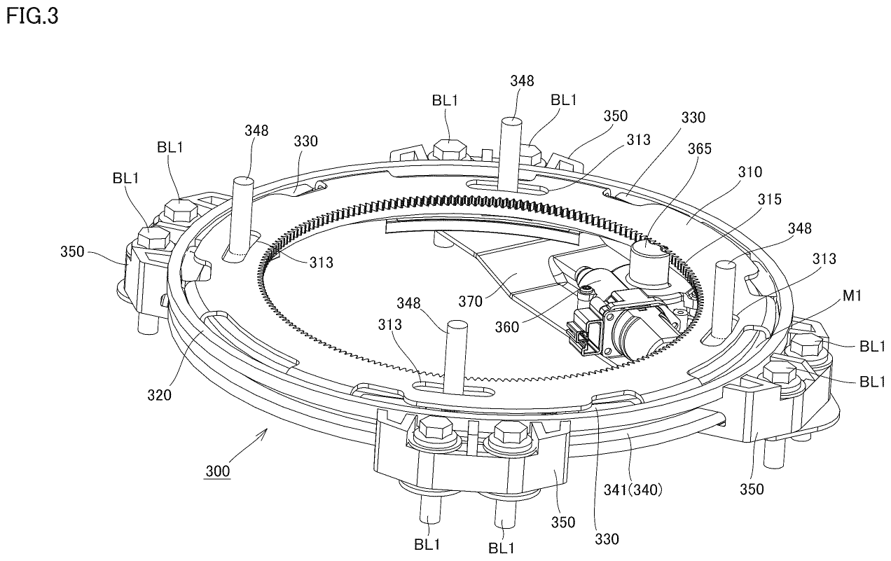

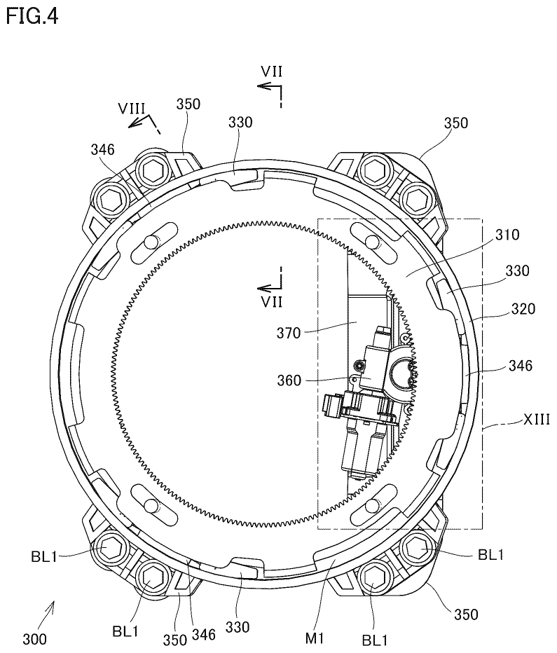

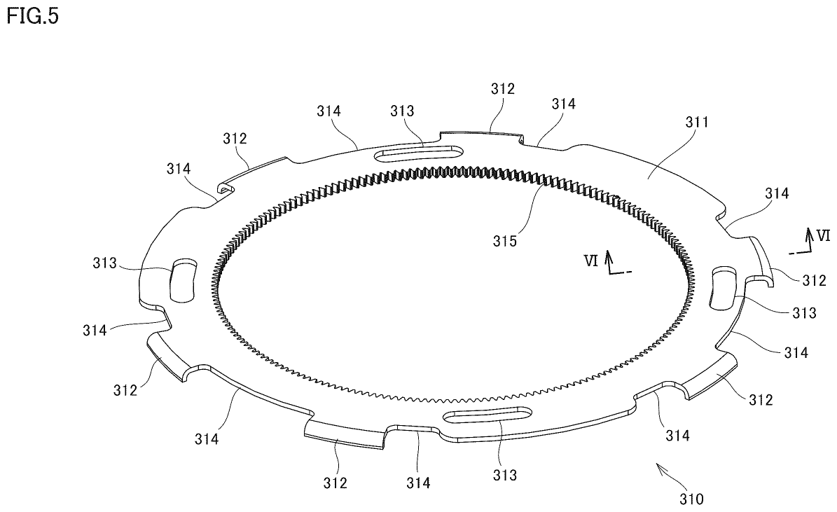

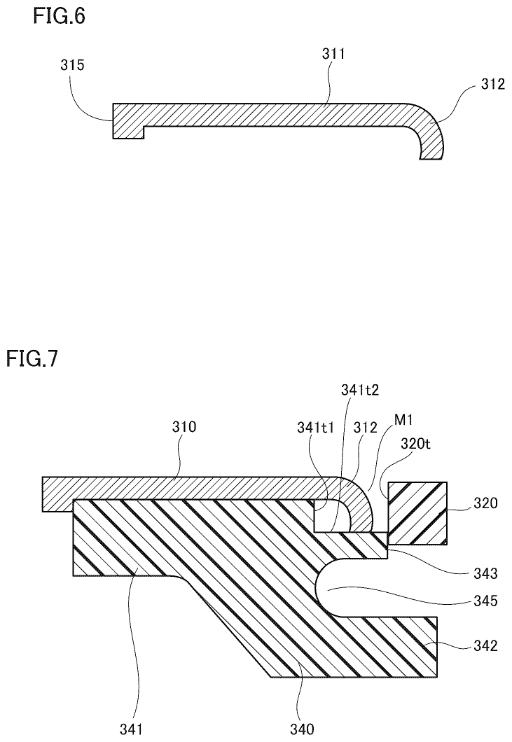

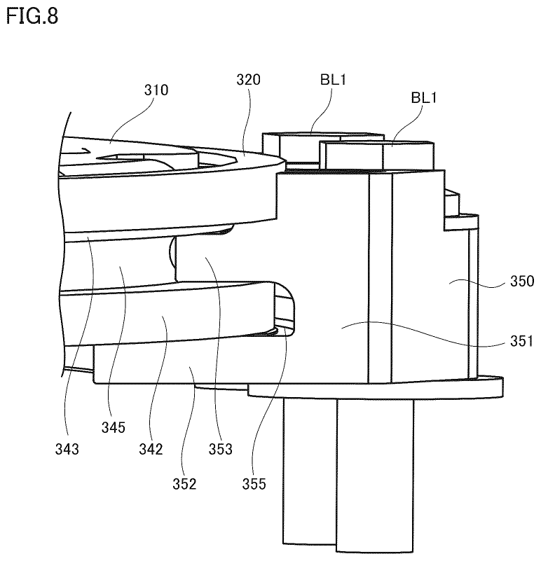

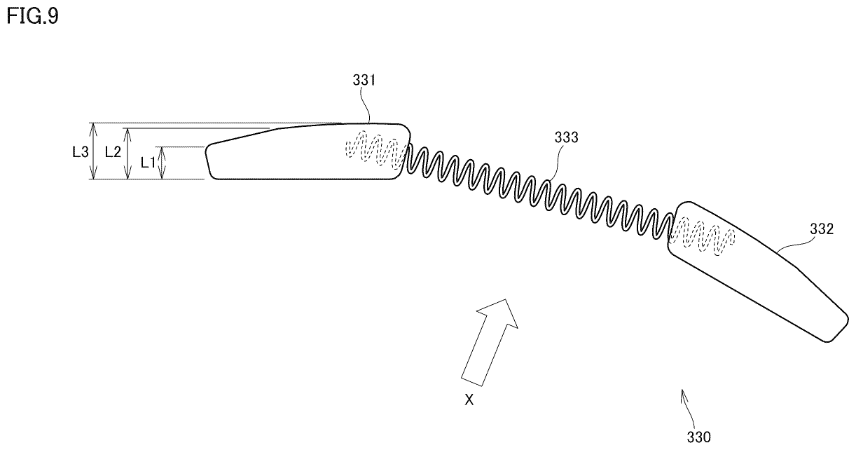

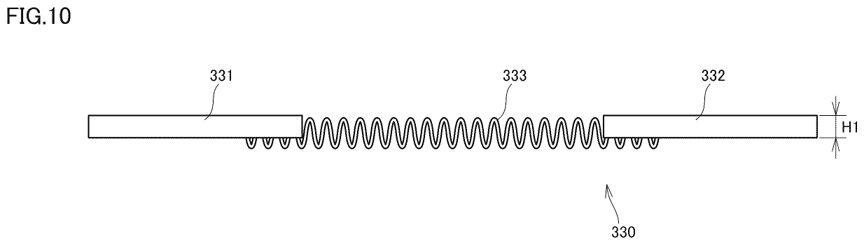

Next, the configuration of seat rotating device 300 will be described with reference to FIGS. 2 to 10. FIG. 2 is an exploded perspective view showing the configuration of seat rotating device 300, FIG. 3 is a perspective view showing the configuration of seat rotating device 300, FIG. 4 is a plan view showing the configuration of seat rotating device 300, FIG. 5 is a perspective view of a release plate of seat rotating device 300, FIG. 6 is a cross-sectional view taken along a line VI-VI as seen in a direction of arrows in FIG. 5, FIG. 7 is a cross-sectional view taken along a line VII-VII as seen in a direction of arrows in FIG. 4, FIG. 8 is a diagram showing a support structure for a rotary disc 340 by a base 350 as seen from VIII in FIG. 4, FIG. 9 is a plan view of a lock unit 330 of seat rotating device 300, and FIG. 10 is a view as seen from an X direction in FIG. 9.

An overall configuration of seat rotating device 300 will be described with reference to FIG. 2. Seat rotating device 300 includes a release plate 310, an outer circumferential ring 320, three sets of lock units 330, a rotary disc 340, four sets of bases 350, one set of drive device 360 (motor), and a bracket 370.

Release plate 310, outer circumferential ring 320, and rotary disc 340 are provided around the same rotation axis CL.

Upwardly extending seat body fixing bolts 348 for supporting seat body 2 are provided on rotary disc 340. Although seat body fixing bolts 348 are provided at a 90-degree pitch on the circumference in the present embodiment, the number of seat body fixing bolts 348 can be varied as needed.

Next, referring to FIGS. 3 to 6, the four sets of bases 350 are fixed to base plate 100 using bolts BL1. Although bases 350 are provided at four locations at a 90-degree pitch in the present embodiment, the number of bases 350 can be varied as needed.

Referring to FIGS. 3 and 4, rotary disc 340 is supported rotatably with respect to base 350. Rotary disc 340 includes a rotary disc body portion 341 formed in an annular shape, and a circumferential edge portion of rotary disc body portion 341 is rotatably supported by base 350. A specific support structure for rotary disc 340 by base 350 will be described later.

Annular release plate 310 having same rotation axis CL as rotary disc 340 is placed on an upper surface of rotary disc 340. Annular outer circumferential ring 320 fixed to base 350 is provided on an outer circumferential side of rotary disc 340. A lock unit housing annular groove M1 is defined between an outer circumferential portion of rotary disc 340 and an inner wall (a second sidewall 320t) of outer circumferential ring 320.

Referring to FIGS. 5 and 6, release plate 310 includes an annular body plate 311.

A rack 315 that meshes with a pinion gear 365 provided on drive device 360 is provided around the entire circumference of an inner circumferential surface of body plate 311.

Arc-shaped elongated holes 313 are provided at four prescribed positions of body plate 311 along a rotation direction. The number of elongated holes 313 can be varied as needed. Abutment portions 312 each having a tip end bent toward rotary disc 340 are provided at six prescribed positions on an outer circumferential surface side of body plate 311.

Abutment portion 312 abuts against lock unit 330 and is used to select between a “rotationally fixed state” and a “rotatable state” which will be described later. Therefore, abutment portions 312 are provided at predetermined positions and have a predetermined arc length. Radially inwardly recessed recesses 314 are provided at positions on both sides of abutment portion 312 in a circumferential direction. A metal material such as a steel plate may be used for body plate 311.

Referring again to FIGS. 3 and 4, seat body fixing bolt 348 provided on rotary disc 340 protrudes upward from elongated hole 313 provided in body plate 311. Release plate 310 is pivotable relative to rotary disc 340 within the arc length of elongated hole 313.

As described above, rack 315 provided on the inner circumferential surface of body plate 311 meshes with pinion gear 365 provided on drive device 360 such as a motor. Drive device 360 is held by bracket 370 fixed to base plate 100. Both end portions of bracket 370 are fastened together and fixed by bolts BL1 when base 350 is fixed to base plate 100.

### <Specific Support Structure for Rotary Disc 340 by Base 350>

The specific support structure for rotary disc 340 by base 350 will be described. Referring to FIG. 7, rotary disc 340 has the same cross-sectional structure at a circumferential edge portion around the entire circumference. Rotary disc 340 includes annular rotary disc body portion 341, and a rotary disc first overhang portion 342 and a rotary disc second overhang portion 343 protruding toward base 350. A rotary disc recess 345 is defined at a position located between rotary disc first overhang portion 342 and rotary disc second overhang portion 343 in a vertical direction.

An outer circumferential portion of an upper surface portion of rotary disc second overhang portion 343 is provided with lock unit housing annular groove M1, lock unit housing annular groove M1 being formed by the outer circumferential portion and the sidewall of outer circumferential ring 320. A rigid resin material may be used for rotary disc 340. As clearly illustrated in FIG. 7, abutment portion 312 described above is located in lock unit housing annular groove M1.

Lock unit housing annular groove M1 is defined by a first sidewall 341t1 (inner wall) and a bottom surface 341t2 at which rotary disc body portion 341 is exposed, and second sidewall 320t (outer wall) serving as an inner wall of outer circumferential ring 320.

Referring to FIG. 8, base 350 includes, on an inner circumferential surface on the rotary disc 340 side, a base recess 355 provided in a base body portion 351, and a base first overhang portion 352 and a base second overhang portion 353 protruding toward rotary disc 340, with base recess 355 lying between base first overhang portion 352 and base second overhang portion 353. A rigid resin material may be used for base 350.

In rotary disc 340 and base 350 configured as described above, base 350 pivotably supports rotary disc 340 such that base second overhang portion 353 is fit into rotary disc recess 345 and rotary disc first overhang portion 342 is fit into base recess 355. Since base 350 pivotably supports rotary disc 340 in this manner, a resin material having a high sliding performance may be used for base 350 and rotary disc 340.

### <Lock Unit 330>

The configuration of lock unit 330 will be described with reference to FIGS. 9 and 10. Lock unit 330 includes a first wedge member 331 and a second wedge member 332 as wedge members. First wedge member 331 and second wedge member 332 are symmetrically arranged. A coil spring 333 as an elastic member is attached between first wedge member 331 and second wedge member 332.

First wedge member 331 and second wedge member 332 are each formed of a resin molded product, and both end portions of coil spring 333 are embedded in first wedge member 331 and second wedge member 332. First wedge member 331 and second wedge member 332 each have a wedge shape that gradually increases from a first width L1 of a front end portion, to a second width L2 of an intermediate portion, and to a third width L3 of a rear end portion. First wedge member 331 and second wedge member 332 each have a thickness H1 in a height direction, which is uniform over the entire length.

### <Housed State of Lock Unit 330 in Lock Unit Housing Annular Groove M1>

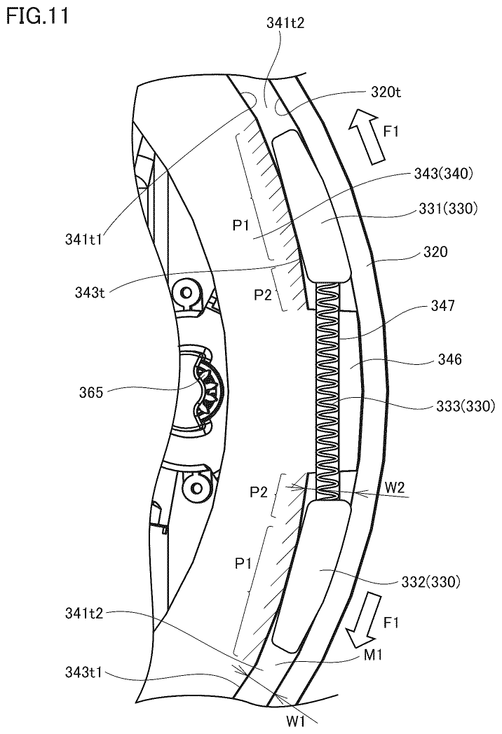

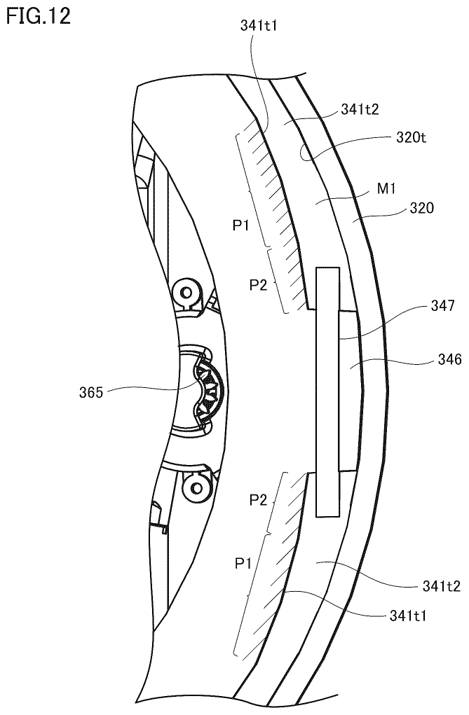

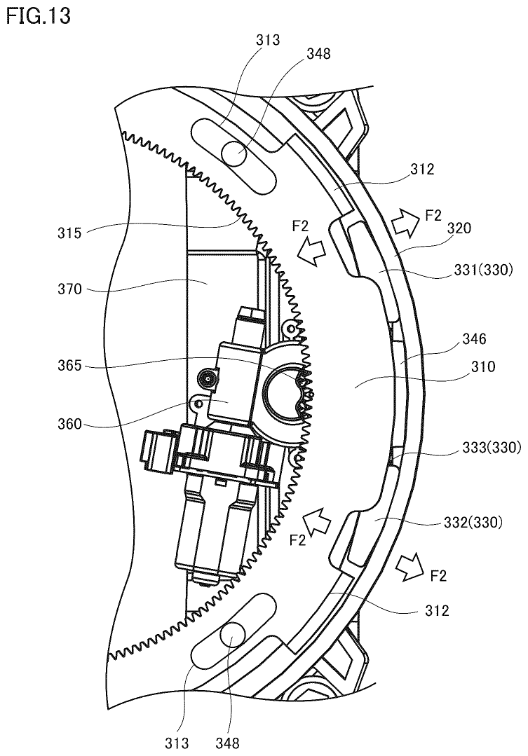

A housed state of lock unit 330 in lock unit housing annular groove M1 will be described with reference to FIGS. 11 and 12. FIG. 11 is a plan view showing the position of the housed state of lock unit 330 in lock unit housing annular groove M1, and FIG. 12 is a partial view showing the configuration of rotary disc body portion 341. In the present embodiment, lock units 330 are provided at three locations, and they function in a synchronized manner. The number of lock units 330 provided can be varied as needed. The housed state of lock unit 330 proximate to drive device 360 will be described below.

Referring to FIGS. 11 and 12, lock unit 330 is housed along lock unit housing annular groove M1. Rotary disc body portion 341 is provided with a rotary disc protrusion 346 protruding toward outer circumferential ring 320 so as to block lock unit housing annular groove M1. Rotary disc protrusion 346 is provided with a coil spring groove 347, and coil spring 333 of lock unit 330 is housed in coil spring groove 347. Although rotary disc protrusions 346 are provided at three locations on the circumference, the number of rotary disc protrusions 346 can be varied as needed depending on the number of lock units 330 provided.

At a position where lock unit 330 is not provided, a first groove width W1 between first sidewall 341t1 (inner wall) of lock unit housing annular groove M1 and second sidewall 320t (outer wall) serving as the outer circumferential ring inner wall is a constant width.

On both sides of rotary disc protrusion 346 where lock unit 330 is provided, on the other hand, a wedge fixed region P1 and a wedge non-fixed region P2 are provided. In wedge fixed region P1 and wedge non-fixed region P2, a distance W2 between first sidewall 341t1 and second sidewall 320t (outer wall) of lock unit housing annular groove M1 gradually increases toward rotary disc protrusion 346.

On the front end side of each of first wedge member 331 and second wedge member 332, there is a region that narrows to a width that prevents movement of first wedge member 331 and second wedge member 332, which is wedge fixed region P1. On the rear end side of each of first wedge member 331 and second wedge member 332, there is a region that widens to a width that allows movement of first wedge member 331 and second wedge member 332, which is wedge non-fixed region P2.

In the state shown in FIG. 11, coil spring 333 is axially compressed while being housed in coil spring groove 347 provided in rotary disc protrusion 346. Lock unit 330 is housed in lock unit housing annular groove M1 in this state. As a result, first wedge member 331 and second wedge member 332 are biased, by a biasing force of coil spring 333, in a direction in which they are pulled apart from each other within lock unit housing annular groove M1 (a direction of arrows F1 in the figure). First wedge member 331 and second wedge member 332 are thus located to be engaged in wedge fixed region P1, which is a narrow region.

The state shown in FIG. 11 is a “rotationally fixed state” by lock unit 330, in which rotation of rotary disc 340 with respect to outer circumferential ring 320 is fixed by an engagement force of first wedge member 331 and second wedge member 332. Selection between the “rotationally fixed state” and “unfixed state” by lock unit 330 will be described later.

### <Adjustment of Rotation Angle by Seat Rotating Device 300>

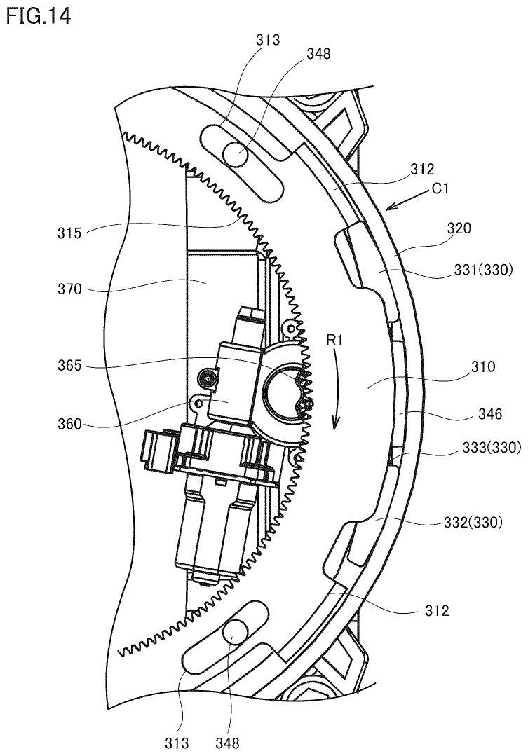

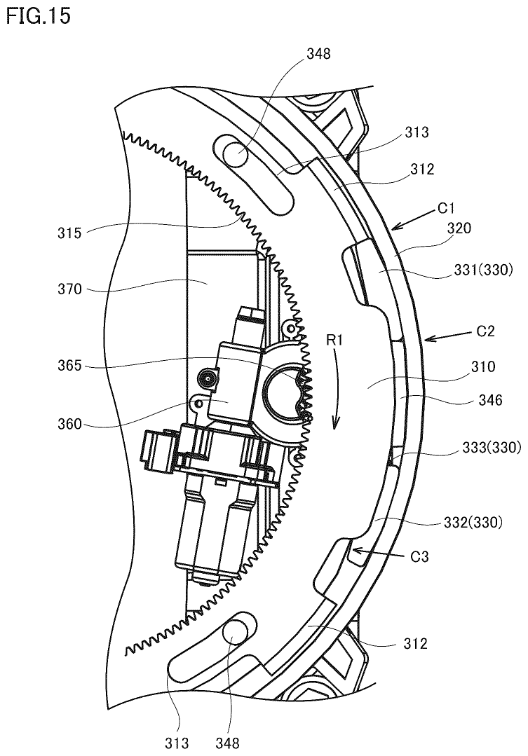

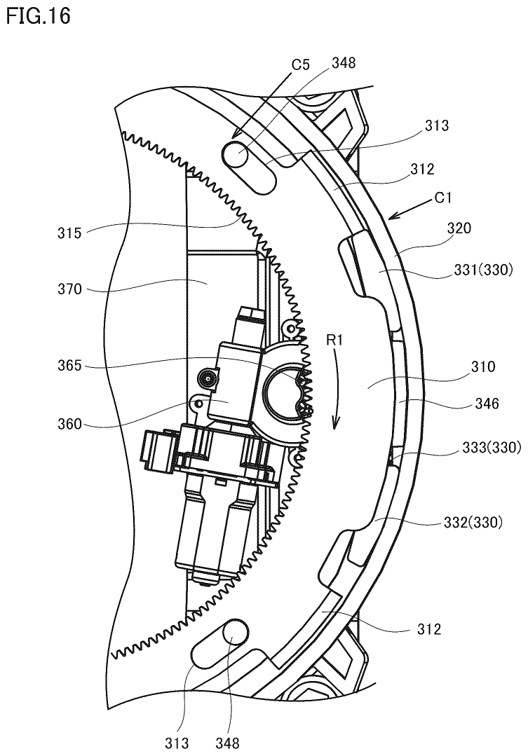

Next, adjustment of a rotation angle by seat rotating device 300 will be described with reference to FIGS. 13 to 16. FIG. 13 is a plan view showing the position of release plate 310 in the “rotationally fixed state,” FIG. 14 is a plan view showing a state after release plate 310 is rotated by a first rotation angle, FIG. 15 is a plan view showing a state after the release plate is rotated by a second rotation angle, and FIG. 16 is a plan view showing another form of release plate 310.

For the adjustment of the rotation angle by seat rotating device 300, the present embodiment includes: a transmission state selection mechanism that is provided between rotary disc 340 and release plate 310 and selects between a “non-transmission state” in which rotation of release plate 310 is not transmitted to rotary disc 340 and a “transmission state” in which rotation of release plate 310 is transmitted to rotary disc 340; and lock unit 330 that is provided between rotary disc 340 and outer circumferential ring 320 and provided to select between the “rotationally fixed state” in which rotation of rotary disc 340 with respect to outer circumferential ring 320 is fixed and the “rotatable state” in which rotation of rotary disc 340 with respect to outer circumferential ring 320 is allowed.

In the present embodiment, the transmission state selection mechanism is constituted by abutment portion 312, first wedge member 331, second wedge member 332, and rotary disc protrusion 346.

In the present embodiment, lock units 330 are provided at three locations and the transmission state selection mechanisms are provided at four locations on the circumference of rotary disc 340. Since all operation states operate in a synchronized manner, an operation state of lock unit 330 and the transmission state selection mechanism that appears in an encircled region XIII in FIG. 4 will be described by way of example.

[Transmission State Selection Mechanism/“Non-Transmission State”] In the “non-transmission state” by the transmission state selection mechanism, abutment portion 312 abuts against first wedge member 331 or second wedge member 332, but first wedge member 331 or second wedge member 332 in abutment with abutment portion 312 does not abut against rotary disc protrusion 346. Therefore, rotation of release plate 310 is not transmitted to rotary disc 340.

[Transmission State Selection Mechanism/“Transmission State”]

In the “transmission state” by the transmission state selection mechanism, abutment portion 312 abuts against first wedge member 331 or second wedge member 332, and first wedge member 331 or second wedge member 332 in abutment with abutment portion 312 abuts against rotary disc protrusion 346, whereby rotation of release plate 310 is transmitted to rotary disc 340, and rotation of rotary disc 340 is allowed.

[“Rotationally Fixed State” (First State)]

The “rotationally fixed state” (first state) in which rotation of rotary disc 340 is fixed will be described with reference to FIG. 13. In the “rotationally fixed state,” first wedge member 331 and second wedge member 332 are located to be engaged in wedge fixed region P1, which is a narrow region, by a biasing force of coil spring 333, as described in FIG. 11. In this state, a pressing force in a horizontal direction (a direction of arrows F2 in the figure) is exerted by the engagement of the wedge members, and rotation of rotary disc 340 with respect to outer circumferential ring 320 is prevented.

In this state, the “non-transmission state” is selected by the transmission state selection mechanism, and the “rotationally fixed state” is selected by lock unit 330.

### [“Rotationally Fixed State”→ “Rotatable State” (Second State)]

In a second state that transitions from the “rotationally fixed state” to the “rotatable state,” first wedge member 331 and second wedge member 332 are located in wedge non-fixed region P2, which is a wide region, whereby rotation of rotary disc 340 with respect to outer circumferential ring 320 is allowed.

Referring to FIG. 14, specifically, drive device 360 is driven to rotate release plate 310 in a prescribed direction. In the figure, release plate 310 is rotated in a counterclockwise rotation direction R1. As a result, abutment portion 312 of release plate 310 abuts against first wedge member 331 (a position indicated by an arrow C1 in the figure).

As shown in FIG. 15, release plate 310 is further rotated in counterclockwise rotation direction R1. As a result, abutment portion 312 of release plate 310 further pushes first wedge member 331, and first wedge member 331 abuts against rotary disc protrusion 346 (a position indicated by an arrow C2 in the figure). By maintaining this state, rotation of release plate 310 is transmitted to rotary disc 340, and synchronous rotation of release plate 310 and rotary disc 340 is allowed.

As described above, since a time lag for rotating only release plate 310 is provided before the state in which rotation of release plate 310 allows rotation of rotary disc 340 is reached, sudden application of rotation of release plate 310 to rotary disc 340 can be suppressed.

The position and the arc length of elongated hole 313 are adjusted so that seat body fixing bolt 348 does not abut against either end portion of elongated hole 313 in the “rotatable state” shown in FIG. 15. The engagement of second wedge member 332 in wedge fixed region P1 (a position indicated by an arrow C3 in the figure), which is a narrow region, rotates rotary disc 340 in a direction that relieves the engagement force of second wedge member 332. Therefore, synchronous rotation of release plate 310 and rotary disc 340 is not prevented by second wedge member 332.

In this second state, drive device 360 is driven from the first state to rotate release plate 310 in one direction (R1 direction), to thereby effect a transition of lock unit 330 from the “rotationally fixed state” to the “rotatable state,” and a transition of the transmission state selection mechanism from the “non-transmission state” to the “transmission state.” As a result, release plate 310 and rotary disc 340 rotate in a synchronized manner, and rotation of rotary disc 340 allows selection of a desired rotation angle position for seat body 2.

Since a time lag for rotating only release plate 310 is provided before the state in which rotation of release plate 310 allows synchronous rotation of rotary disc 340 is reached, sudden application of rotation of release plate 310 to rotary disc 340 can be suppressed.

As shown in FIG. 16, another form of the transmission state selection mechanism can be employed. The transmission state selection mechanism shown in FIG. 15 is constituted by abutment portion 312, first wedge member 331, second wedge member 332, and rotary disc protrusion 346. Another form of the transmission state selection mechanism shown in FIG. 16 is constituted by abutment portion 312, elongated hole 313, and seat body fixing bolt 348.

Specifically, first, drive device 360 is driven to rotate release plate 310 in the prescribed direction, as described in FIG. 14. Seat body fixing bolt 348 protrudes from elongated hole 313, and seat body fixing bolt 348 is not in contact with either end portion of elongated hole 313.

Then, as shown in FIG. 16, release plate 310 is further rotated in counterclockwise rotation direction R1. At this time, first wedge member 331 abuts against abutment portion 312, and seat body fixing bolt 348 abuts against one of the end portions of elongated hole 313 before first wedge member 331 abuts against rotary disc protrusion 346. The position and the arc length of elongated hole 313 are adjusted so that the state described above can be achieved.

Then, in the same manner as described in FIG. 15, release plate 310 is rotated in counterclockwise rotation direction R1. As a result, abutment portion 312 of release plate 310 further pushes first wedge member 331, and seat body fixing bolt 348 abuts against one end of elongated hole 313 (a position indicated by an arrow C5 in the figure). By maintaining this state, rotation of release plate 310 is transmitted to rotary disc 340, and synchronous rotation of release plate 310 and rotary disc 340 is allowed.

### [“Rotatable State”→ “Rotationally Fixed State” (Third State)]

After the desired rotation angle position is selected for seat body 2 by rotation of release plate 310 as described above, seat rotating device 300 is returned to the first state and rotation of seat body 2 is fixed.

Specifically, after the desired rotation angle position is selected for seat body 2 in the second state described above, drive device 360 is reversely driven to rotate release plate 310 by a prescribed angle in a clockwise rotation direction. The clockwise rotation direction is another direction opposite to the counterclockwise rotation direction, which is one direction R1. This effects a transition of lock unit 330 from the “rotatable state” to the “rotationally fixed state” and a transition of the transmission state selection mechanism from the “transmission state” to the “non-transmission state,” to return seat rotating device 300 to the first state shown in FIG. 13.

As described above, in seat rotating device 300 in the present embodiment, since seat body 2 can be rotated to an arbitrary rotation angle position (stepless adjustment) and then fixed, comfort of a user using the seat device can be improved. Furthermore, since the fixation structure using the wedges is employed for lock unit 330, outer circumferential ring 320 and rotary disc 340 can be reliably fixed to each other without wobbling (a gap). As a result, comfort of a user using the seat device can be improved.

Furthermore, the number of components can be reduced, the thickness of seat rotating device 300 in the vertical direction can be suppressed, a low profile of seat rotating device 300 can be achieved, and assembly work can be facilitated.

Furthermore, since the resin material is used for rotary disc 340 and base 350, a light weight of seat rotating device 300 can be achieved. Furthermore, since the configuration in which base 350 is divided into a plurality of bases is employed, a light weight of seat rotating device 300 can be achieved. Furthermore, since the support structure shown in FIG. 8 is employed as the support structure between rotary disc 340 and base 350, it is possible to achieve a support structure having a high strength with a thickness and a shape that cannot be achieved by a steel plate.

Furthermore, since the rotation of seat body 2 to a desired rotation angle position and the fixation of seat body 2 can be performed by one drive device 360, an increasing cost required for seat rotating device 300 can be suppressed.

### (Modification of Lock Unit)

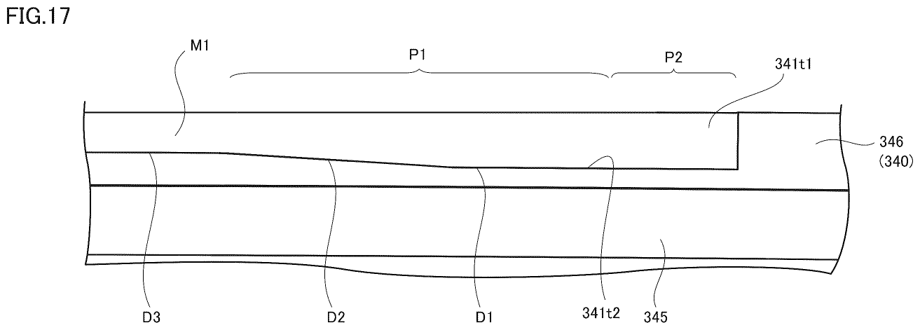

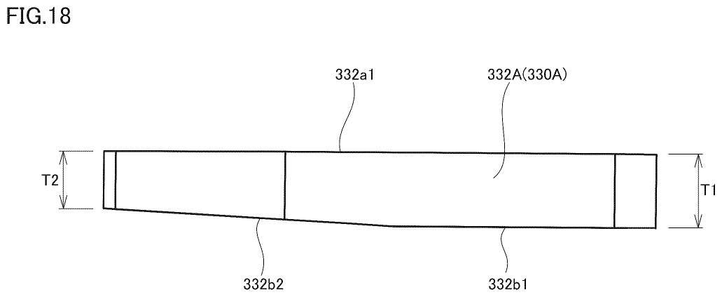

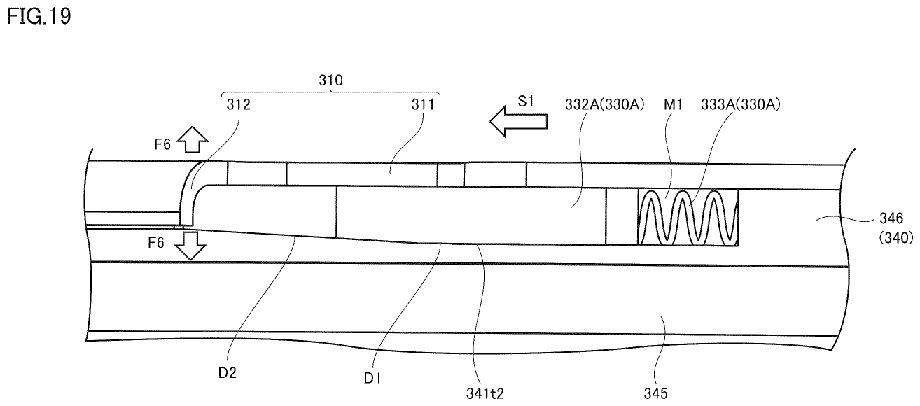

A modification of the lock unit will be described with reference to FIGS. 17 to 19. FIG. 17 is a side view showing the shape of lock unit housing annular groove M1 in rotary disc body portion 341, FIG. 18 is a side view showing a form of a second wedge member 332A, and FIG. 19 is a side view showing a lock state by second wedge member 332A.

As shown in FIG. 10, first wedge member 331 and second wedge member 332 for use in lock unit 330 described above are uniformly provided over the entire length. Therefore, the effect of engagement by the wedges is produced only in the lateral direction (see arrows F2 in FIG. 13). A lock unit 330A in the modification is configured, on the other hand, to produce the effect of engagement by the wedges in the vertical direction as well.

Lock unit 330A has the same basic configuration as lock unit 330 described above (see FIGS. 9 and 10), and includes a first wedge member 331A, second wedge member 332A, and a coil spring 333A. The shapes of second wedge member 332A and lock unit housing annular groove M1 will be described below. The shape of lock unit housing annular groove M1 in a plan view is the same as the shape shown in FIG. 11.

Referring to FIG. 17, bottom surface 341t2 of lock unit housing annular groove M1 corresponding to wedge fixed region P1 and wedge non-fixed region P2 of lock unit housing annular groove M1 is provided with a first depth groove portion D1 having the greatest depth on the rotary disc protrusion 346 side, and includes a tapered second depth groove portion D2 gradually decreasing in depth with distance from rotary disc protrusion 346, and a third depth groove portion D3 having the smallest depth. Second depth groove portion D2 and third depth groove portion D3 constitute a shallow groove region having a decreasing groove depth.

Referring to FIG. 18, second wedge member 332A has a height T1 on the rotary disc protrusion 346 side (the side to which coil spring 333A is attached), and has a flat upper surface 332al. A lower surface, on the other hand, has a first bottom surface 332b1 that maintains thickness T1, and a second bottom surface 332b2 that is inclined to gradually decrease in thickness toward the front end (the left side in the figure). A second wedge member 332B has a thickness H2 on the front end side (H1>H2).

Referring to FIG. 19, the state shown in this figure is the same as the state shown in FIG. 13, in which second wedge member 332A is engaged in wedge fixed region P1, which is a narrow region, by a biasing force of coil spring 333A. In this state, second bottom surface 332b2 of second wedge member 332A is moved in an S1 direction in the figure along tapered second depth groove portion D2 in bottom surface 341t2 of lock unit housing annular groove M1. As a result, second wedge member 332A is located in the shallow groove region. Second wedge member 332A is thus moved upward (a direction of an arrow F6 in the figure) and pressed against release plate 310.

As a result, in addition to the pressing force in the lateral direction (see the direction of arrows F2 in FIG. 13), a pressing force in the vertical direction (the direction of arrows F6 in the figure) toward release plate 310 and toward bottom surface 341t2 of lock unit housing annular groove M1 can be generated by the engagement of second wedge member 332A.

With this configuration, the “rotationally fixed state” (first state) in which rotation of rotary disc 340 with respect to outer circumferential ring 320 is fixed can be further stabilized.

It will be understood by those skilled in the art that the exemplary embodiment described above is a specific example of aspects below.

### Aspect I

A seat rotating device that rotates a seat body with respect to a placement base, the seat rotating device comprising:
a rotary disc that supports the seat body;
a base that supports the rotary disc rotatably with respect to the placement base;
an outer circumferential ring fixed to the base and arranged on an outer circumferential side of the rotary disc;
a release plate placed on the rotary disc and having a same rotation center as the rotary disc;
a drive device that rotates the release plate about the rotation center as a rotation axis;
a transmission state selection mechanism provided between the rotary disc and the release plate, the transmission state selection mechanism selecting between
   a non-transmission state in which rotation of the release plate is not transmitted to the rotary disc, and
   a transmission state in which rotation of the release plate is transmitted to the rotary disc; and
a lock unit provided between the rotary disc and the outer circumferential ring, the lock unit being provided to select between
   a rotationally fixed state in which rotation of the rotary disc with respect to the outer circumferential ring is fixed, and
   a rotatable state in which rotation of the rotary disc with respect to the outer circumferential ring is allowed, wherein
when the seat rotating device is in a first state, the non-transmission state is selected by the transmission state selection mechanism, and the rotationally fixed state is selected by the lock unit,
when the seat rotating device is in a second state, the drive device is driven from the first state to rotate the release plate in one direction, to thereby effect a transition of the lock unit from the rotationally fixed state to the rotatable state, and a transition of the transmission state selection mechanism from the non-transmission state to the transmission state, whereby the release plate and the rotary disc rotate in a synchronized manner, and rotation of the rotary disc allows selection of a desired rotation angle position for the seat body, and
when the seat rotating device is in a third state, after the desired rotation angle position is selected for the seat body in the second state, the drive device is reversely driven to rotate the release plate by a prescribed angle in another direction opposite to the one direction, to thereby effect a transition of the lock unit from the rotatable state to the rotationally fixed state, and a transition of the transmission state selection mechanism from the transmission state to the non-transmission state, to return the seat rotating device to the first state.

According to this seat rotating device, since the seat body can be rotated to an arbitrary rotation angle position (stepless adjustment) and then fixed, comfort of a user using the seat device can be improved.

### Aspect II

The seat rotating device according to Aspect I, wherein
an outer circumferential portion of the rotary disc is provided with a lock unit housing annular groove, the lock unit housing annular groove being formed by the outer circumferential portion and the outer circumferential ring,
the lock unit includes a wedge member housed in the lock unit housing annular groove,
the lock unit housing annular groove includes a wider region and a narrower region than a width of the wedge member in a plan view,
in the rotationally fixed state, the wedge member is located to be engaged in the narrower region, whereby rotation of the rotary disc with respect to the outer circumferential ring is prevented, and
in the rotatable state, the wedge member is located in the wider region, whereby rotation of the rotary disc with respect to the outer circumferential ring is allowed.

According to this aspect, the outer circumferential ring and the rotary disc can be reliably fixed to each other without wobbling (a gap). As a result, comfort of a user using the seat device can be improved.

### Aspect III

The seat rotating device according to Aspect II, wherein
the release plate includes an abutment portion located in the lock unit housing annular groove, and
the abutment portion abuts against the wedge member as a result of rotation and movement of the release plate, to move the wedge member from the narrower region to the wider region, to thereby effect a transition of the lock unit from the rotationally fixed state to the rotatable state.

According to this aspect, the outer circumferential ring and the rotary disc can be reliably fixed to each other without wobbling (a gap). As a result, comfort of a user using the seat device can be improved.

### Aspect IV

The seat rotating device according to Aspect III, wherein
the lock unit includes a first wedge member and a second wedge member as the wedge member,
the first wedge member and the second wedge member are biased by an elastic member in a direction in which they are pulled apart from each other within the lock unit housing annular groove,
the elastic member is housed, at the outer circumferential portion of the rotary disc, in a rotary disc protrusion protruding toward the outer circumferential ring so as to block the lock unit housing annular groove,
the first wedge member and the second wedge member are housed in the lock unit housing annular groove, with the rotary disc protrusion lying between the first wedge member and the second wedge member, and
when the abutment portion does not abut against the first wedge member or the second wedge member, the first wedge member and the second wedge member are located to be engaged in the narrower region by a biasing force of the elastic member, and the rotationally fixed state of the lock unit is maintained.

According to this aspect, the outer circumferential ring and the rotary disc can be reliably fixed to each other without wobbling (a gap). As a result, comfort of a user using the seat device can be improved.

### Aspect V

The seat rotating device according to Aspect IV, wherein
the transmission state selection mechanism is constituted by the abutment portion, the wedge member, and the rotary disc protrusion,
in the non-transmission state, the abutment portion abuts against the wedge member, but the wedge member does not abut against the rotary disc protrusion, and
in the transmission state, the wedge member abuts against the abutment portion and the rotary disc protrusion, and rotation of the release plate allows rotation of the rotary disc.

According to this aspect, since a time lag for rotating only the release plate is provided before the state in which rotation of the release plate allows synchronous rotation of the rotary disc is reached, sudden application of rotation of the release plate to the rotary disc can be suppressed.

### Aspect VI

The seat rotating device according to any one of Aspects I to IV, wherein
the transmission state selection mechanism is constituted by the release plate and the rotary disc,
in the non-transmission state, the abutment portion abuts against the wedge member, but the wedge member does not abut against the rotary disc protrusion,
the release plate includes an arc-shaped elongated hole provided along a rotation direction,
the rotary disc includes a rotary disc protruding pin protruding from the elongated hole and connected to the seat body,
in the non-transmission state, the rotary disc protruding pin does not abut against either end portion of the elongated hole, and
in the transmission state, the wedge member abuts against the abutment portion, and the rotary disc protruding pin abuts against one of the end portions of the elongated hole before the wedge member abuts against the rotary disc protrusion.

According to this aspect, since a time lag for rotating only the release plate is provided before the state in which rotation of the release plate allows synchronous rotation of the rotary disc is reached, sudden application of rotation of the release plate to the rotary disc can be suppressed.

### Aspect VII

The seat rotating device according to any one of Aspects II to VI, wherein
at a position of the rotationally fixed state,
the lock unit housing annular groove is provided with a shallow groove region having a decreasing groove depth, and
the wedge member is located in the shallow groove region, whereby the wedge member is moved upward and pressed against the release plate.

According to this aspect, the “rotationally fixed state” in which rotation of the rotary disc with respect to the outer circumferential ring is fixed can be further stabilized.

### Aspect VIII

The seat rotating device according to any one of Aspects I to VII, wherein
the base is divided into four bases on a circumference and supports the rotary disc at the four bases.

According to this aspect, a light weight of the seat rotating device can be achieved. Furthermore, a support structure having a high strength can be achieved between the rotary disc and the base.

### Aspect IX

The seat rotating device according to any one of Aspects I to VIII, wherein
the rotary disc includes, on an outer circumferential surface on the base side, a rotary disc recess, and a rotary disc first overhang portion and a rotary disc second overhang portion protruding toward the base, with the rotary disc recess lying between the rotary disc first overhang portion and the rotary disc second overhang portion,
the base includes, on an inner circumferential surface on the rotary disc side, a base recess, and a base first overhang portion and a base second overhang portion protruding toward the rotary disc, with the base recess lying between the base first overhang portion and the base second overhang portion, and
the base supports the rotary disc such that the base second overhang portion is fit into the rotary disc recess and the rotary disc first overhang portion is fit into the base recess.

According to this aspect, a light weight of the seat rotating device can be achieved. Furthermore, a support structure having a high strength can be achieved between the rotary disc and the base.

Although embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. A seat rotating device that rotates a seat body with respect to a placement base, the seat rotating device comprising:
a rotary disc that supports the seat body;
a base that supports the rotary disc rotatably with respect to the placement base;
an outer circumferential ring fixed to the base and arranged on an outer circumferential side of the rotary disc;
a release plate placed on the rotary disc and having a same rotation center as the rotary disc;
a drive device that rotates the release plate about the rotation center as a rotation axis;
a transmission state selection mechanism provided between the rotary disc and the release plate, the transmission state selection mechanism selecting between
a non-transmission state in which rotation of the release plate is not transmitted to the rotary disc, and
a transmission state in which rotation of the release plate is transmitted to the rotary disc; and
a lock unit provided between the rotary disc and the outer circumferential ring, the lock unit being provided to select between
a rotationally fixed state in which rotation of the rotary disc with respect to the outer circumferential ring is fixed, and
a rotatable state in which rotation of the rotary disc with respect to the outer circumferential ring is allowed, wherein
when the seat rotating device is in a first state, the non-transmission state is selected by the transmission state selection mechanism, and the rotationally fixed state is selected by the lock unit,
when the seat rotating device is in a second state, the drive device is driven from the first state to rotate the release plate in one direction, to thereby effect a transition of the lock unit from the rotationally fixed state to the rotatable state, and a transition of the transmission state selection mechanism from the non-transmission state to the transmission state, whereby the release plate and the rotary disc rotate in a synchronized manner, and rotation of the rotary disc allows selection of a desired rotation angle position for the seat body, and
when the seat rotating device is in a third state, after the desired rotation angle position is selected for the seat body in the second state, the drive device is reversely driven to rotate the release plate by a prescribed angle in another direction opposite to the one direction, to thereby effect a transition of the lock unit from the rotatable state to the rotationally fixed state, and a transition of the transmission state selection mechanism from the transmission state to the non-transmission state, to return the seat rotating device to the first state.

2. The seat rotating device according to claim 1, wherein
an outer circumferential portion of the rotary disc is provided with a lock unit housing annular groove, the lock unit housing annular groove being formed by the outer circumferential portion and the outer circumferential ring,
the lock unit includes a wedge member housed in the lock unit housing annular groove,
the lock unit housing annular groove includes a wider region and a narrower region than a width of the wedge member in a plan view,
in the rotationally fixed state, the wedge member is located to be engaged in the narrower region, whereby rotation of the rotary disc with respect to the outer circumferential ring is prevented, and
in the rotatable state, the wedge member is located in the wider region, whereby rotation of the rotary disc with respect to the outer circumferential ring is allowed.

3. The seat rotating device according to claim 2, wherein
the release plate includes an abutment portion located in the lock unit housing annular groove, and
the abutment portion abuts against the wedge member as a result of rotation and movement of the release plate, to move the wedge member from the narrower region to the wider region, to thereby effect a transition of the lock unit from the rotationally fixed state to the rotatable state.

4. The seat rotating device according to claim 3, wherein
the lock unit includes a first wedge member and a second wedge member as the wedge member,
the first wedge member and the second wedge member are biased by an elastic member in a direction in which they are pulled apart from each other within the lock unit housing annular groove,
the elastic member is housed, at the outer circumferential portion of the rotary disc, in a rotary disc protrusion protruding toward the outer circumferential ring so as to block the lock unit housing annular groove,
the first wedge member and the second wedge member are housed in the lock unit housing annular groove, with the rotary disc protrusion lying between the first wedge member and the second wedge member, and
when the abutment portion does not abut against the first wedge member or the second wedge member, the first wedge member and the second wedge member are located to be engaged in the narrower region by a biasing force of the elastic member, and the rotationally fixed state of the lock unit is maintained.

5. The seat rotating device according to claim 4, wherein
the transmission state selection mechanism is constituted by the abutment portion, the wedge member, and the rotary disc protrusion,
in the non-transmission state, the abutment portion abuts against the wedge member, but the wedge member does not abut against the rotary disc protrusion, and
in the transmission state, the wedge member abuts against the abutment portion and the rotary disc protrusion, and rotation of the release plate allows rotation of the rotary disc.

6. The seat rotating device according to claim 4, wherein
the transmission state selection mechanism is constituted by the release plate and the rotary disc,
in the non-transmission state, the abutment portion abuts against the wedge member, but the wedge member does not abut against the rotary disc protrusion, the release plate includes an arc-shaped elongated hole provided along a rotation direction,
the rotary disc includes a rotary disc protruding pin protruding from the elongated hole and connected to the seat body,
in the non-transmission state, the rotary disc protruding pin does not abut against either end portion of the elongated hole, and
in the transmission state, the wedge member abuts against the abutment portion, and the rotary disc protruding pin abuts against one of the end portions of the elongated hole before the wedge member abuts against the rotary disc protrusion.

7. The seat rotating device according to claim 2, wherein
at a position of the rotationally fixed state,
the lock unit housing annular groove is provided with a shallow groove region having a decreasing groove depth, and
the wedge member is located in the shallow groove region, whereby the wedge member is moved upward and pressed against the release plate.

8. The seat rotating device according to claim 1, wherein
the base is divided into four bases on a circumference and supports the rotary disc at the four bases.

9. The seat rotating device according to claim 1, wherein
the rotary disc includes, on an outer circumferential surface on the base side, a rotary disc recess, and a rotary disc first overhang portion and a rotary disc second overhang portion protruding toward the base, with the rotary disc recess lying between the rotary disc first overhang portion and the rotary disc second overhang portion,
the base includes, on an inner circumferential surface on the rotary disc side, a base recess, and a base first overhang portion and a base second overhang portion protruding toward the rotary disc, with the base recess lying between the base first overhang portion and the base second overhang portion, and
the base supports the rotary disc such that the base second overhang portion is fit into the rotary disc recess and the rotary disc first overhang portion is fit into the base recess.
